(19) United States
(12) Patent Application Publication
(10) Pub. No.: US 2019/0338537 A1
(43) Pub. Date: Nov. 7, 2019

(54) TROWEL/FLOAT WITH LEVEL AND REPLACEABLE SURFACES

(71) Applicants: Robert Black, Monroe, NY (US); James Wickstead, Mendham, NJ (US)

(72) Inventors: Robert Black, Monroe, NY (US); James Wickstead, Mendham, NJ (US)

(21) Appl. No.: 16/403,529

(22) Filed: May 4, 2019

Related U.S. Application Data
(60) Provisional application No. 62/666,932, filed on May 4, 2018.

(51) Int. Cl. E04F 21/16; G01C 9/28

(52) U.S. Cl. CPC E04F 21/163; G01C 9/28

(57) ABSTRACT

This disclosure relates to a trowel and/or float having a utilitarian and adjustable level built-in for ease of use and creating uniform, properly angled, smooth surfaces, and replaceable undersides for creating various effects all in one simple to use tool.

The present application claims the benefit of the prior filed U.S. Provisional Application No. 62/666,932, filed by the present inventors on May 4, 2018, which is incorporated herein by reference.

### FIELD OF THE INVENTION

This disclosure relates to a trowel and/or float having a utilitarian and adjustable level built-in for ease of use and creating uniform, properly angled, smooth surfaces, and replaceable undersides for creating various effects all in one simple to use tool.

### BACKGROUND

Tools for smoothing out a hard setting material before it sets have been known for ages. Over the years, trowels and/or floats, as these tools have become to be known, have been developed with different shapes, different handles, different underside surfaces that come into contact with the hard setting material to create different surface textures, and even with various angles to create slopes in the hard setting materials.

Typically, to create a sloped surface the level of skill of a worker and the independent use of several tools, such as a desired trowel and a level, and sometimes a variety of trowels and a variety of levels, would be implemented. Moreover, the desire for surface texture differences along the slope required a multitude of tools, as well.

Attempts have been made to incorporate a level within a trowel to combine the functionality into a single tool. For example, in U.S. Pat. No. 6,568,021, titled TROWEL WITH LEVELS, disclosed is, “a trowel includes a series of levels embedded in the handle for measuring the inclination of a surface being finished. The trowel includes a flat base plate, with a handle having two ends each secured to the plate to define a grip area therebetween, This construction provides an extremely rigid structure, where the handle and its included levels cannot flex angularly relative to the base plate or blade. At least one of the handle ends, and optionally both ends, includes two mutually orthogonally disposed level indicators installed therein for simultaneously measuring the level or slope of a surface being worked, in two mutually perpendicular axes. The opposite handle end may also include a pair of similarly arranged levels, if so desired. The levels may comprise bubble or spirit levels, electronic levels with audible output, and/or other level types as desired.”

In another example, in U.S. Pat. No. 4,253,214, titled FINISH WORK TROWEL, disclosed is, “a plasterers trowel designed for finished coats of plaster consisting of an elongated flat rectangular rigid base plate with an elongated handle secured at one end only to the base plate. A flexible resilient essentially non-compressible trowel blade with a smooth lower surface and thickness in the order of ⅛″ is secured to the base plate. The trowel blade is formed with a feathered knife edge at its periphery with the periphery of the trowel blade extending beyond the periphery of the base plate.”

In another example, in U.S. Pat. No. 3,166,776, titles TROWEL WITH INTERCHANGEABLE BLADES, disclosed is, “a trowel . . . which comprises a single handle member and a plurality of interchangeable blades adapted to be readily connected to the handle.”

Thus, there have been attempts and a need shown for a simple to use, all-in-one, trowel and/or float, with interchangeable blades, and built-in, easy to use levels to allow a user increased flexibility in creating sloped surfaces of varying textures. One of the shortfalls in the prior attempts is that any included level is fixed in place and requires the user to constantly monitor and approximate the angle that a tool is maintained to create a uniform slope. Another shortfall is the ease of interchangeability of blades. Another shortfall is the cleanability of the overall tool when the complexity of adding levels and interchangeability of blades is introduced.

It is an object of the present disclosure to teach a device that incorporates one or more levels. The levels could be spirit levels, bubble levels, laser levels, electronic levels, audible levels, or any other type of known level that can be completely imbedded within the base of a trowel handle for easy cleaning and yet remain fully functional and adjustable.

It is another object of the present disclosure to teach a device that is rugged, lightweight, and has an easy functional interchangeable blade method to provide for a quick change for different surface textures of the hard setting underlay material.

The present disclosure teaches an ideal trowel including at least two mutually orthogonal level indicators that are adjustable within their housing such that, instead of the user having to maintain the level indicating the desired degree of slope, the user adjusts the level to the desired slope and then the user maintains the trowel level indicator at center, a much easier task.

The present disclosure also teaches an ideal trowel that is rugged, light-weight, easy-to-clean and comprising an easy-off, easy-on interchangeable snap-in-place bottom blade tray—essentially a removable base which provides the ability to replace worn or damaged blade surfaces or simply change desired blade textures.

None of the disclosed prior art references or other known prior art, alone or in combination, teach the salient and proprietary features of the present disclosure as just described.

### SUMMARY

The present disclosure teaches embodiments of a trowel that comprise a plurality of adjustable levels, interchangeable blade surfaces, in an injection molded frame with a rubberized overlay.

### BRIEF DESCRIPTION OF THE DRAWINGS

FIG. 1 depicts one embodiment of a trowel as disclosed herein depicting a handle (1), a base (2) having an area (2a) co-planar with the underside working surface (not seen in this view), and a plurality of embedded adjustable levels (3) in said area (2a). The handle may have at least one access area (10) to a fastening means to secure a bottom surface

FIG. 2 depicts an embodiment of a trowel as disclosed herein in an exploded view depicting a handle (1), a base (2) having an area (2a) co-planar with the underside working surface, a plurality of embedded adjustable levels (3) in said area (2a), and a snap-on tray for blade interchangeability providing an underside working surface (4) with one snap shown (5). In one embodiment, and alternatively, the snap (5) could be replaced with quarter-turn fastener(s), or the top side of the blade could be outfitted with a magnet means (5a) to mate with a magnetic underside of the base (2).

FIG. 3 depicts one embodiment of a trowel as disclosed herein with a view from underneath depicting a handle (1), a base (2) having an area (2a) co-planar with the underside working surface, and the underside of a snap-on tray for blade interchangeability (4).

FIG. 4 depicts one embodiment of a trowel as disclosed herein depicting a close-up view of the snap (5) of a snap-on tray (4), that fits over and snaps onto a base (2), for blade interchangeability.

FIG. 5 depicts one embodiment of a trowel as disclosed herein depicting a close-up view of the underside of a snap on tray 4, featuring a smooth blade (6), which may in alternative embodiments have teeth or a ridged surface to provide some bite in gripping mortar to be spread making the process easier and more effective.

FIG. 6. Depicts one embodiment of a level as used within the trowel as disclosed herein depicting a spirit level with a bubble (7) that indicates a degree of levelness with index lines (8) and an adjustment mechanism (9) to vary the horizontal with respect to the plane of the blade.

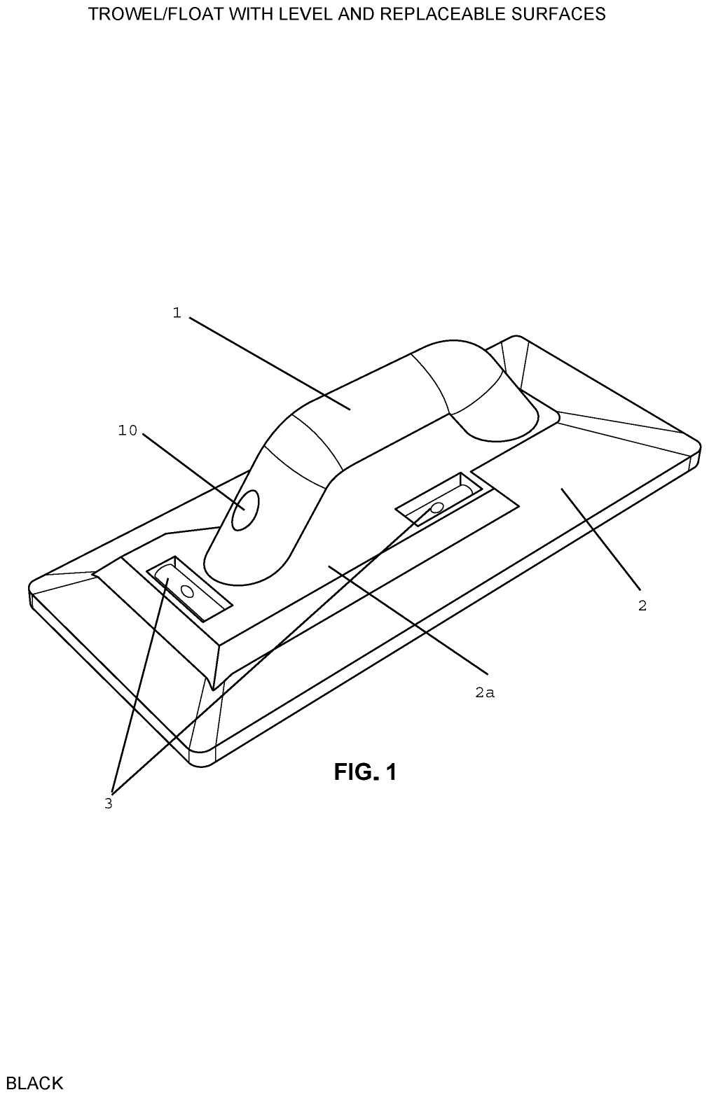

### DETAILED DESCRIPTION

For clarity of disclosure, and not by way of limitation, the detailed description of the invention is divided into the following subsections that describe or illustrate certain features, embodiments or applications of the present invention.

### Definitions

“handle” as used herein means a part of an implement by which such implement is held, carried or controlled and is generally conducive to manipulation by a human hand. It will have at least one connection point to a base and in a preferred embodiment, have two connection points for stability in maintaining a constant level reading.

“base” as used herein means a part of an implement attached to a handle that acts as a housing or support for the other features of the implement, namely, at least a blade and a level.

“blade” as used herein means a part of an implement attached to the bottom or underside of a base of a trowel that is the part of the implement configured to come into contact with the material the trowel is designed to spread, smooth, level, texture or otherwise manipulate.

“level” as used herein means any device or mechanism capable of determining a desired plane line or adjusting something to a horizontal plane surface or otherwise determining an imaginary line or surface of a desired plane or elevation.

“trowel” as used herein means an implement that is a hand tool used to spread, smooth, level, texture or otherwise manipulate concrete, plaster, mastic or other spreadable material used in the construction trades, and comprises at least a handle, a base, and a blade, and in preferred embodiments, also a level and wherein the blade is configured to be easily replaceable.

“float” as used herein means a specialized type of trowel that is used to spread grout into the grooves of tiles that have previously been laid in place and forcing the grout or other cement into place within those tile spaces.

### The System and Method of the Present Invention

In one embodiment, this disclosure teaches a trowel, comprising, a base, a handle, an interchangeable blade, and at least one configurable level.

In one embodiment, two levels are disposed within the base of the trowel, each being oriented 90° to each other. In one embodiment, the levels are each static such that when the base and the corresponding attached blade is in the desired position, the level will indicate, against a static index line, how to maintain that desired plane. In an alternative embodiment, each level is adjustable within its base housing such that if in either the front to back or the left to right plane, an angled plane is desired, such angle can be set by manipulating the angle of the level to be the new horizontal making it easier to maintain throughout use.

In one embodiment, blades of various shapes, sizes and/or textures are easily interchangeable to allow use in various environments and to create various desired textures within the surface of the material to be spread, smoothed, leveled, textured or otherwise manipulated. In one embodiment, a blade made of wood, desirable in some circumstances, is incorporated onto the bottom of an interchangeable blade and in this configuration, whereas wood normally warps, the blade composite here will prevent warping.

In one embodiment, a blade is configured with a molded in texture to provide “tooth” that better moves cement or other material resulting in faster and more accurate placement. In this embodiment, this feature can be ridges or teeth, angled or not, of various heights, all depending on the type of mortar or other material to be used.

In one embodiment, the handle and base are configured and molded from a special “slippery” plastic to provide a non-stick surface making the overall implement easy to clean.

In one embodiment, levels used herein are spirit levels. In an alternative embodiment, any type of known level device could be used that imparts easy readability, adjustability, and durability. In one embodiment, whatever type of level is used, it is housed in a compartment that is in an area of the base that is co-planar with the blade when in place and further has an adjustment feature to allow the level to be adjusted to any desired plane such that when the level indicates horizontal, the plane of the blade is a desired angle from that horizontal.

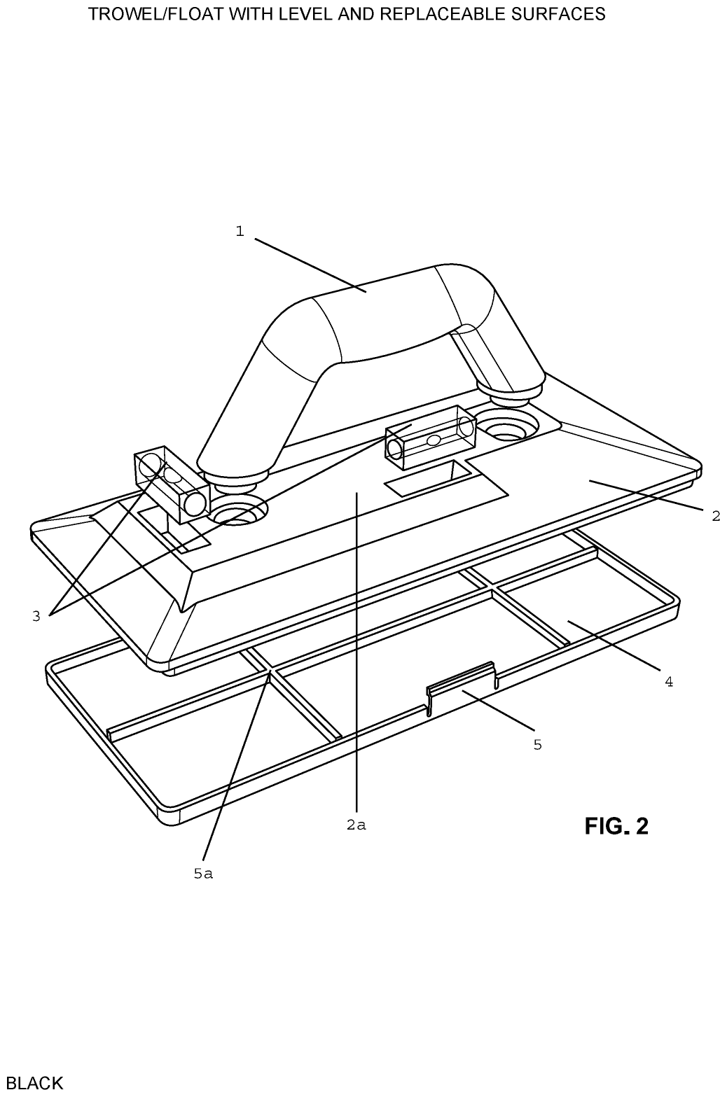

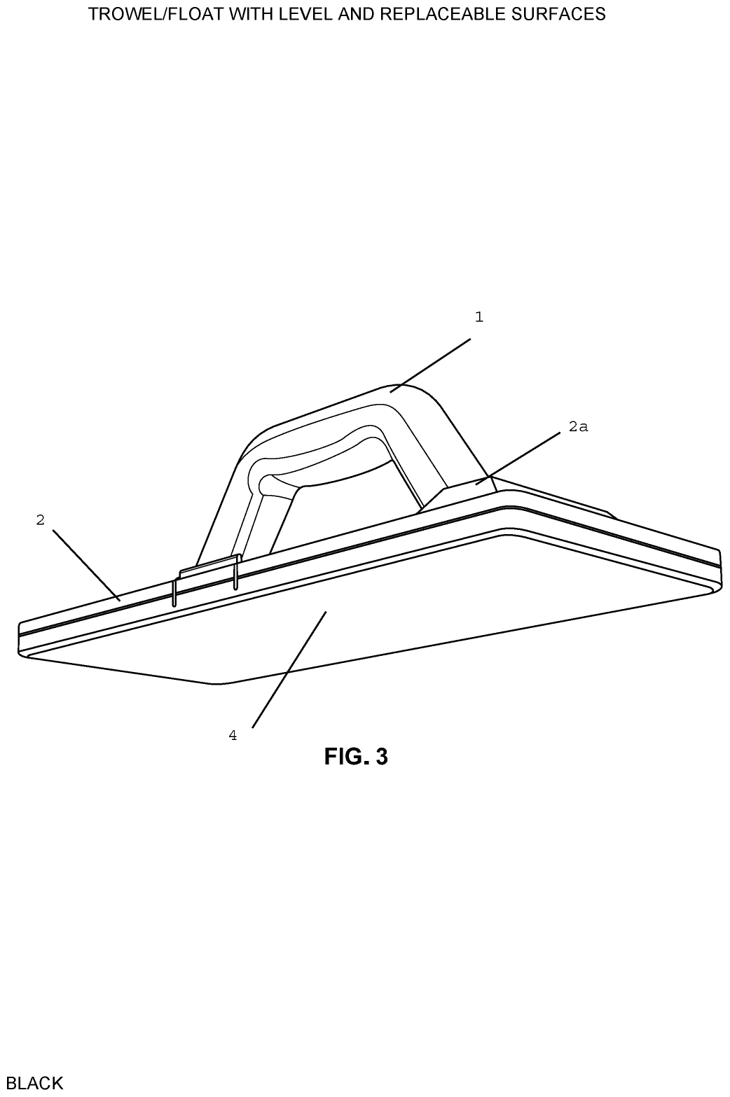

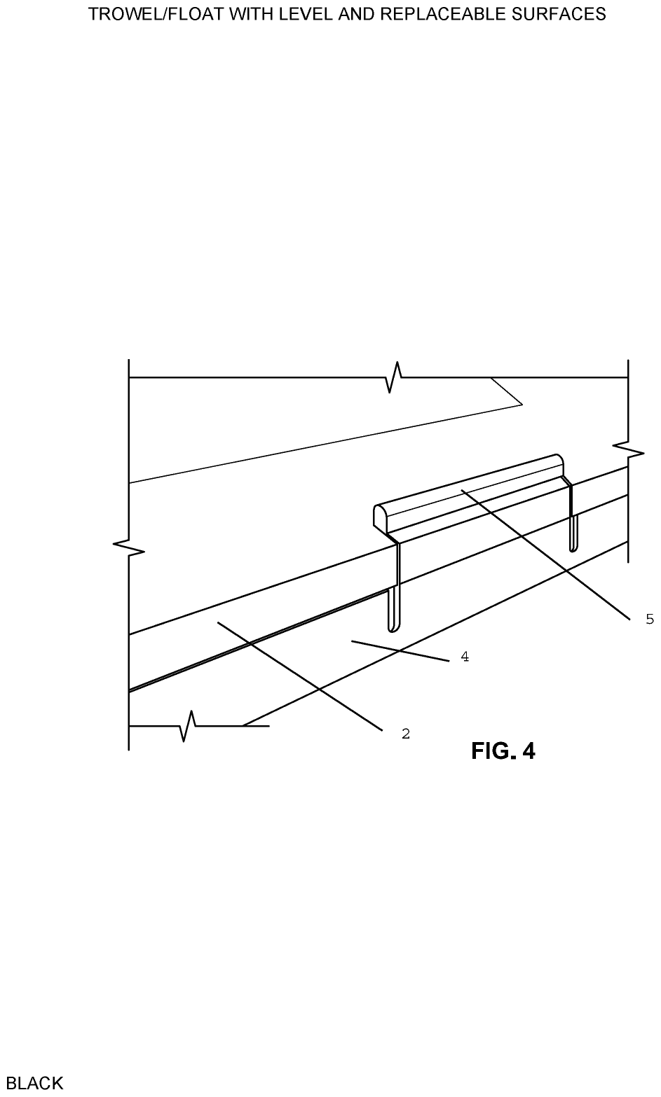

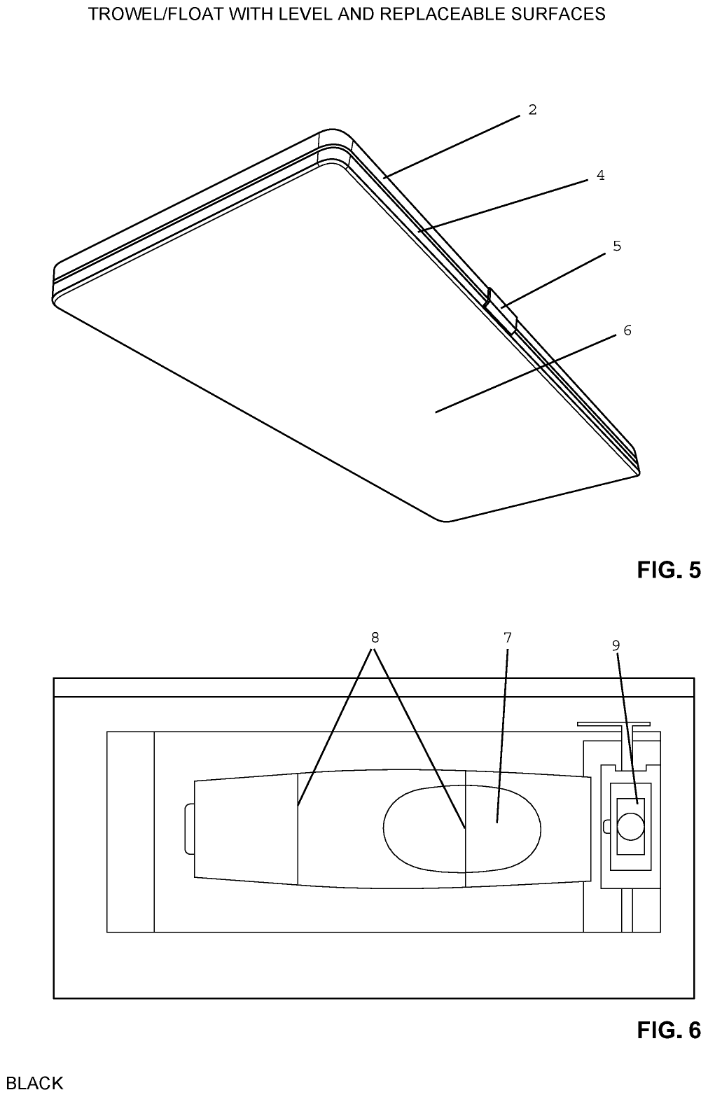

In one embodiment, the base is configured to accept various blades through a snap-on/snap-off configuration making blade interchangeability fast and easy, while maintaining the same planar orientation from blade to blade. Moreover, in this embodiment, one handle/base/levels combination can be used with any number of blades and thus, blades when worn or broken do not necessitate a replacement of anything other than the worn or broken blade. In one embodiment, the snap is located on the blade and there is nothing to break on the base. This allows for separate “work surfaces” to be sold, each with a different texture for different applications. Additionally in this embodiment, the handle may be attachable through the bottom of the base making it changeable, as well, as the connection would be covered up by a snapped into place blade (for example, See FIG. 2). In one embodiment, a blade could be a composite allowing for one material (such as wood that warps with moisture contact) to be affixed onto another material (such as plastic that does not warp) creating a blade with dual properties (a wood contact surface with the non-warping features of plastic).

In one embodiment, there many be any number of known attachment means for replaceably attaching the blade to the base, For example, and not by way of limitation, the blade could attach to the base by way of magnets (as shown in FIG. 2).

In one embodiment, the base and handle are molded in one contiguous unit to prevent any liquid infusion. In an alternative embodiment, the handle and base are separately molded and then permanently attached using ultrasonic assembly to achieve the same result.

In one embodiment, the handle has a rubberized overlay for better handling in wet environments.

### EXAMPLES

The present invention is further illustrated, but not limited by, the following examples.

Use of a trowel or float has always been a matter of skill and judgment. Holding a set angle to achieve and ideal slope of ½″ in height every 12″ in length is difficult. But, with built in levels, maintaining a specific slope is a matter of holding a particular level index. Alternatively, a level could be adjustable so that an adjustment could be made so that the user maintains the new “horizontal level” which in actuality is a desired slope.

When installing a mud floor or a shower floor, a ribbon is run around the perimeter of the space. Pressure is used from the outside inwards (or towards the drain location). Utilizing the levels, a constant and similar pressure is easily maintained resulting in a constant and uniform pitch. As noted above, maintaining the specific slope is a matter of holding a particular level index or, alternatively, setting an adjustable level so that a new horizontal is established, making the process even easier. Thus, in an embodiment with an adjustable level, a user adjusts the level so that a blade with an angle is set to a level with a bubble in the center making it easier and more consistent to use.

Publications cited throughout this document are hereby incorporated by reference in their entirety. Although the various aspects of the invention have been illustrated above by reference to examples and preferred embodiments, it will be appreciated that the scope of the invention is defined not by the foregoing description but by the following claims properly construed under principles of patent law.

Each and every feature described herein, and each and every combination of two or more of such features, is included within the scope of the present invention provided that the features included in such a combination are not mutually exclusive.

What is claimed is:

1. A trowel comprising:
a handle;
a base configured to accept a specially configured and replaceable blade and at least one area that is co-planar with a blade when attached in place;
an at least one level configured to be set in place into said area in said base that is co-planar with a blade when attached in place; and
a blade specially configured with a means for replaceably attaching said blade to said base.

2. The trowel of claim 1, wherein it comprises two levels configured to be set in place into said area in said base that is co-planar with a blade when attached in place.

3. The trowel of claim 2, wherein said two levels are in 90° orientation to each other.

4. The trowel of claim 1 wherein the handle and base are made from a non-stick plastic.

5. The trowel of claim 1 wherein the at least one level is adjustable.

6. The trowel of claim 3 wherein both levels are adjustable.

7. The trowel of claim 1 wherein the blade is a composite where one material is wood and the other is plastic.

8. The trowel of claim 1 wherein the blade is a composite of two dissimilar materials.

9. The trowel of claim 1 wherein said means for replaceably attaching said blade to said base is via snaps.

10. The trowel of claim 1 wherein said means for replaceably attaching said blade to said base is via magnets.

11. The trowel of claim 1 wherein said means for replaceably attaching said blade to said base is via a quarter turn fastener.
